(19) United States
(12) Patent Application Publication
(10) Pub. No.: US 2013/0341214 A1
(43) Pub. Date: Dec. 26, 2013

(54) GAMING ACCESSORY FOR A PORTABLE ELECTRONIC DEVICE, GAMING SYSTEMS AND METHODS

(71) Applicant: ZAGG Intellectual Property Holding Co., Inc., Salt Lake City, UT (US)

(72) Inventors: Jeffrey King, Kaysville, UT (US); David Gengler, Draper, UT (US); Terence Hulsman, North Salt Lake, UT (US); Arthur Healey, Centerville, UT (US)

(21) Appl. No.: 13/922,384

(22) Filed: Jun. 20, 2013

Related U.S. Application Data
(60) Provisional application No. 61/661,976, filed on Jun. 20, 2012.

(51) Int. Cl. A63F 13/02

(52) U.S. Cl. CPC A63F 13/02
USPC 206/216

(57) ABSTRACT

A case for a portable electronic device, such as a mobile telephone (e.g., a smart phone, etc.), a portable media player or a tablet computer, includes at least one game control element for use in playing a game on the portable electronic device. In addition to the game control element, the protective case may include a receptacle and a base, which may be part of the receptacle or operatively associated with the receptacle. The receptacle is configured to receive or otherwise carry the portable electronic device, and may be configured to protect the portable electronic device. The receptacle may be configured to move relative to the base in a manner that enables a user to select an orientation of a display of the portable electronic device relative to the at least one game control element. The at least one game control element may be moved between a storage position, where it may appear to be an integral part of the case, and a gaming position where it is accessible from a location laterally beyond the receptacle and any portable electronic device held by the receptacle. A gaming system may include a case and a portable electronic device. A gaming method may include use of the case to play a game on a portable electronic device.

### CROSS-REFERENCE TO RELATED APPLICATION

A claim for the benefit of priority to the Jun. 20, 2012 filing date of U.S. Provisional Application No. 61/661,976, titled GAMING CONTROLLER AND INTEGRATED PROTECTIVE COVER FOR PORTABLE ELECTRONIC DEVICE, AND METHODS ASSOCIATED THEREWITH (“the '976 Provisional Application”) is hereby made pursuant to 35 U.S.C. §119(e). The entire disclosure of the '976 Provisional Application is hereby incorporated herein.

### TECHNICAL FIELD

This disclosure relates generally to accessories for portable electronic devices and, more specifically, to cases (including, but not limited to, protective cases) for portable electronic devices. Even more specifically, the disclosed accessories include controls for gaming, which may be configured for use with a portable electronic device when the portable electronic device is used to play a video game. Gaming systems are also disclosed, as are methods for using portable electronic devices.

### SUMMARY

In various embodiments, an accessory for a portable electronic device may be configured to carry the portable electronic device and to facilitate play of one or more video games with the portable electronic device. Such an accessory may include a receptacle and at least one game control element. In a specific embodiment, an accessory may include two game control elements, which may be configured to be positioned on opposite sides of a portable electronic device. In some embodiments, an accessory may also include a base that carries the receptacle and the at least one game control element. Because of its dual (or more) functionality, the accessory may be referred to as a “case” or as a “game controller.”

The receptacle of the accessory may be configured to carry a portable electronic device, such as a mobile telephone (e.g., a smart phone, etc.), a portable media player, a tablet computer or the like. Without limitation, the receptacle may be configured to carry the portable electronic device by engaging one or more peripheral corners of the portable electronic device, one or more peripheral edges of the portable electronic device, or any combination of the foregoing. The receptacle, or a base that carries the receptacle, may be configured to cover a back side of the portable electronic device. In some embodiments, the receptacle may comprise a protective case for the portable electronic device.

In embodiments where the accessory includes a base, the receptacle may be configured to move relative to the base. In a specific embodiment, the receptacle may be rotatably associated with the base. Such rotational association may enable movement of the receptacle, and any portable electronic device carried thereby, to two or more orientations. Without limitation, the receptacle and the base may be configured to position the receptacle, and any portable electronic device carried thereby, in at least a landscape orientation and a portrait orientation.

The at least one game controller may be configured to operatively couple with a portable electronic device carried by the receptacle to enable actuation of functions of a video game played on the portable electronic device. Each game controller may move relative to the receptacle or, if the accessory includes a base, relative to the base. Each game controller may have a storage position and a gaming position. In its storage position, a game controller may be positioned beneath the receptacle and, in some embodiments, to comprise an integral part of a case for a portable electronic device. In its gaming position, the game controller may be accessible from a location laterally adjacent to the receptacle and, thus, a portable electronic device carried by the receptacle. The accessory may be configured in such a way that each game controller may slide relative to the receptacle and/or the base (if any) to enable movement between the storage position and the gaming position. Such sliding movement may comprise linear sliding, arcuate sliding or the like. Alternatively, a game controller may rotate or pivot relative to the receptacle and/or base (if any) to enable movement between the storage position and the gaming position.

A gaming system may include an embodiment of an accessory, as well as a portable electronic device with which the accessory is configured to be used.

A portable electronic device may be assembled with the receptacle of an accessory that also includes one or more game control elements. The receptacle may protect the portable electronic device from mechanical damage (e.g., impact that may occur during an accidental drop, other types of impact, scratches on covered surfaces, exposure to the elements, etc.). When a portable electronic device is used to play a video game or perform any other function (e.g., execute another app, etc.) in which a game controller may be useful, a game control element in the gaming position may be used as an actuator in the video game or other function. When the game control element is not in use, it may be placed in the storage position. With the game control element in the storage position, the portable electronic device may be used for a non-gaming function, such as a phone call, text messaging, e-mailing, playing audio, playing video viewing images, using the internet and executing a non-game app.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIG. 1 is a front perspective view of an embodiment of an accessory, showing an embodiment of portable electronic device assembled with the accessory;

FIG. 2 is a left side view of the assembly of FIG. 1;

FIG. 3 is a right side view of the assembly of FIG. 1;

FIG. 4 is a front view of the assembly of FIG. 1;

FIG. 5 is a rear view of the assembly of FIG. 1;

FIG. 6 is a bottom side view of the assembly of FIG. 1;

FIG. 7 is a top side view of the assembly of FIG. 1;

FIG. 8 is a front perspective view of the assembly of FIG. 1, showing embodiments of game control elements in gaming positions relative to a receptacle of the accessory;

FIG. 9 is a rear perspective view of the assembly of FIG. 1 in the arrangement shown in FIG. 8;

FIG. 10 is a left side view of the assembly of FIG. 1 in the arrangement shown in FIG. 8;

FIG. 11 is a right side view of the assembly of FIG. 1 in the arrangement shown in FIG. 8;

FIG. 12 is a front view of the assembly of FIG. 1 in the arrangement shown in FIG. 8;

FIG. 13 is a rear view of the assembly of FIG. 1 in the arrangement shown in FIG. 8;

FIG. 14 is a variation of the embodiment of an accessory shown in FIGS. 1-13;

FIG. 15 is a front perspective view of another embodiment of an accessory for use with a portable electronic device; and

FIG. 16 is a schematic representation of operation of an accessory as at least one game control element of the accessory is used to play a video game on a portable electronic device.

### DETAILED DESCRIPTION

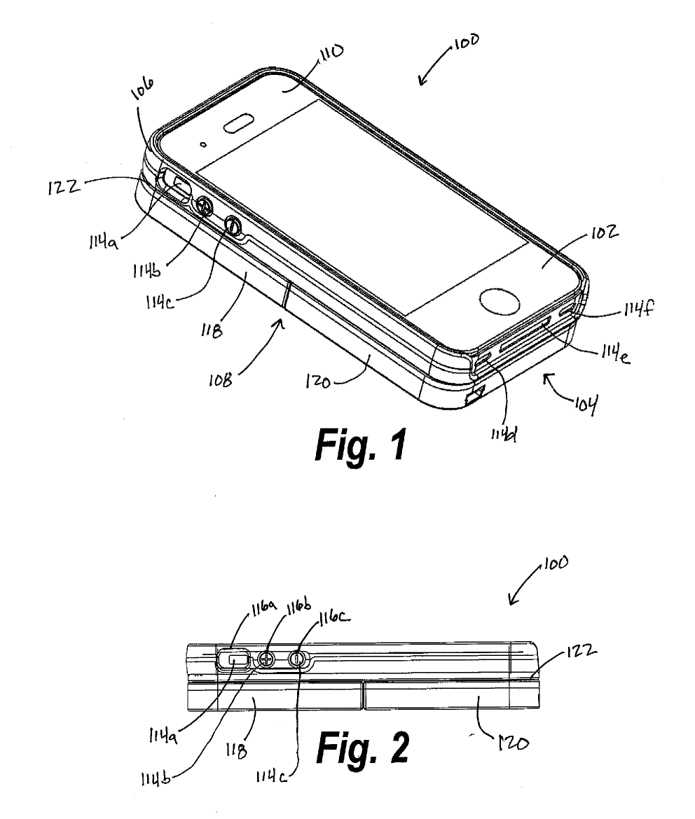

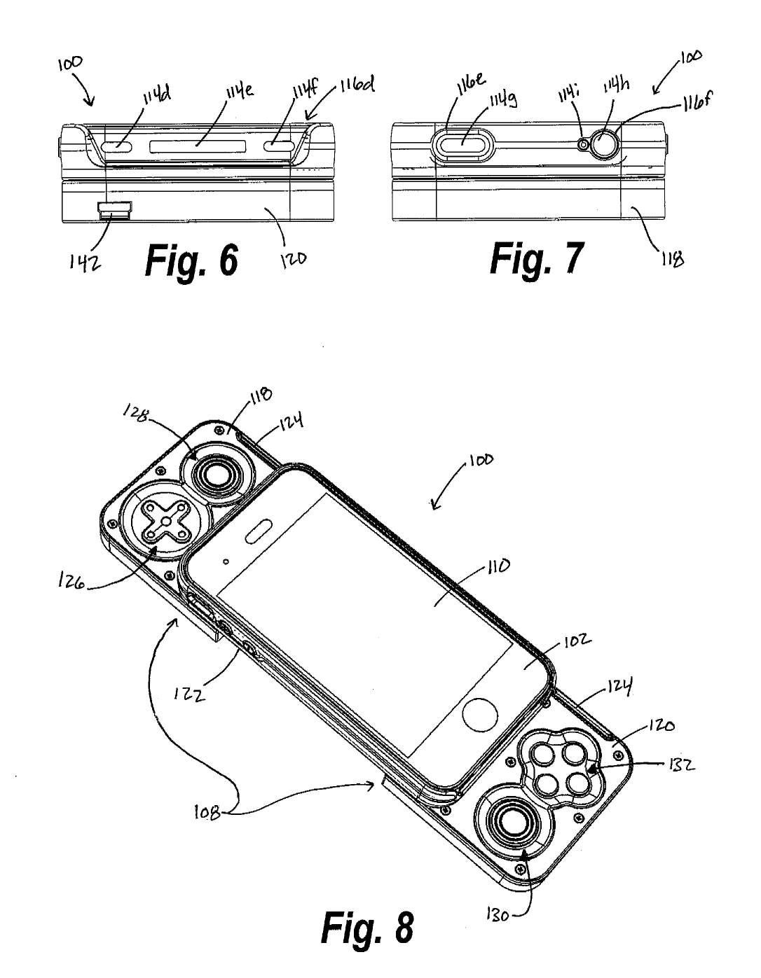

With reference to FIGS. 1-7, an embodiment of an accessory 108 for use with a portable electronic device 102 is depicted. As depicted, the accessory 108 includes a receptacle 104 and a pair of game control elements 118 and 120. When a portable electronic device 102 is assembled with the receptacle 104, the accessory 108 and the portable electronic device 102 form a gaming assembly 100.

The receptacle 104 of the accessory 108 is configured to carry a portable electronic device 102, such as a mobile telephone, a portable media player, a tablet computer or the like. The receptacle 104 may be configured to protect a portable electronic device 102. The receptacle 104 may reside on a front side of a base 122, which may be part of the receptacle 104 or a separate element to which the receptacle 104 may be secured. Corners 106 may protrude from corners of the base 122, and may be configured to extend over, or cover, and optionally engage corresponding corners of the portable electronic device 102. The receptacle 104 may include side walls 107 that protrude from peripheral edges of the base 122, and which may be configured to extend over, or cover, and optionally engage corresponding peripheral edges, or sides or ends, of the portable electronic device 102. One or more corners 106 and/or one or more side walls 107 of the receptacle 104 may include laterally extending lips, which may be configured to extend slightly over a surface 110 (e.g., a display surface, a back surface, etc.) of the portable electronic device 102 to hold the portable electronic device 102 within the receptacle 116. Depending upon its configuration, the receptacle 104 may comprise a case, or even a protective case, for the portable electronic device 102.

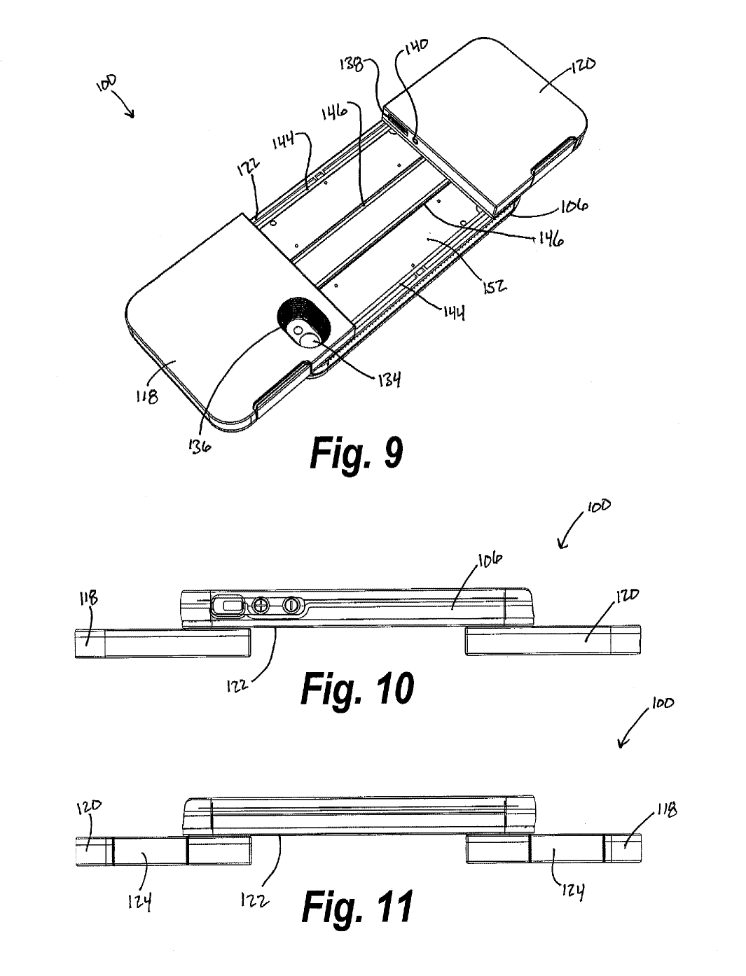

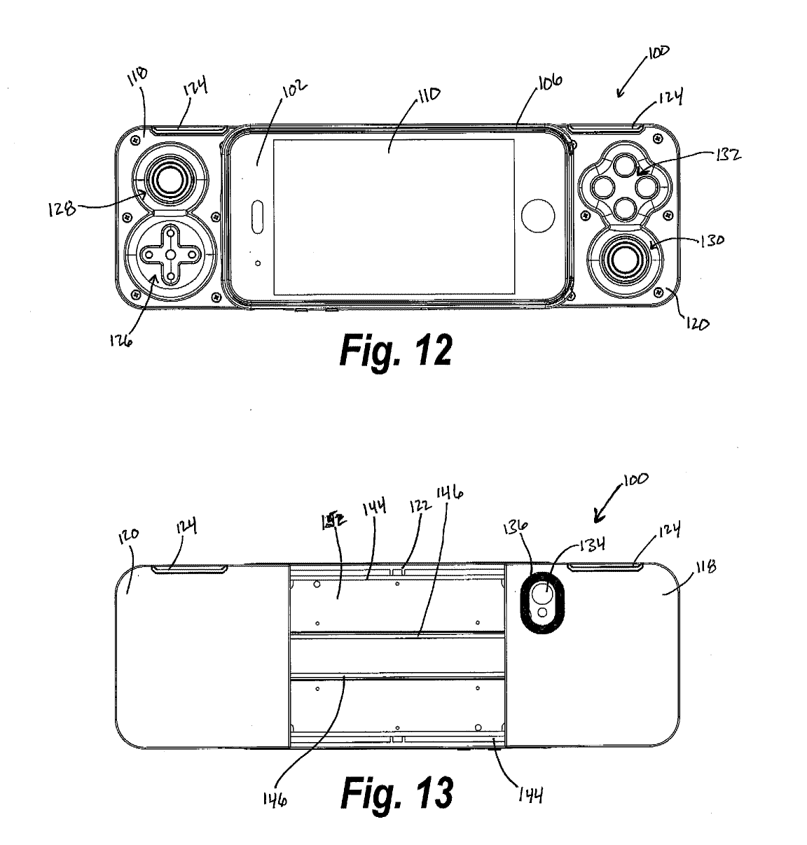

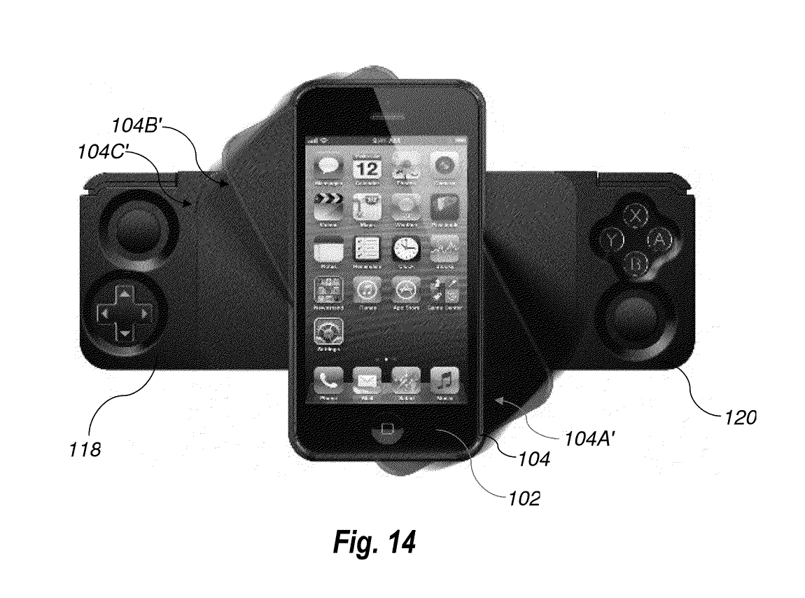

In some embodiments, the orientation of the receptacle 104 may be fixed relative to the orientations of other features of the accessory 108, including its game control elements 118 and 120. Alternatively, as illustrated by FIG. 14, an accessory 108′ may include a receptacle 104′ that is configured to rotate between at least two orientations relative to the game control elements 118′ and 120′ (e.g., the landscape orientation shown in FIGS. 8 and 12, a portrait orientation 104A′, a plurality of intermediate orientations 104B′, 104C′, etc.). As the receptacle 104′ rotates from one orientation to another, any electronic device 102′ (and its display) carried thereby will also rotate from one orientation to another. In this regard, the base (which may be configured like base 122 shown in FIGS. 1, 3, 8 and 9) of the receptacle 104′ may comprise a turntable that rotates between two or more positions relative to a base (see, e.g., base 152 of FIG. 9, etc.) of the accessory 108′. Such a configuration may place and hold the receptacle 104′ in two or more discrete orientations, or it may enable placement and maintenance of the receptacle 104′ in a larger number, or even an infinite number, of orientations.

The accessory 108 may include features that accommodate various elements and/or features of the portable electronic device 102. As a non-limiting example, as illustrated by FIGS. 1, 2, 6 and 8, in embodiments where the receptacle 116 includes walls that extend over portions of the peripheral edges of the portable electronic device 102, the side walls 107 of the receptacle 104 may be configured with recessed areas, apertures and/or other features 114a-114f (e.g., slots, holes, buttons, etc.) to accommodate and provide access to or otherwise enable use of various elements 114a-114i of the portable electronic device 102, such as buttons, switches, ports, microphones, speakers, camera lenses and the like. As another non-limiting example, as depicted by FIGS. 5, 9 and 13, the accessory 108 may include one or more features that align with camera lenses and/or flashes 134, such as an aperture (not shown) that extends through the base 122 of the receptacle 104 and a corresponding aperture 136 through one of the game control elements 118. The aperture 136 through game control element 118 may be positioned to align with the camera lens and/or flash 134 when the game control element 118 is in its stored position; the aperture through the base 122 may expose the camera lens and/or flash 134 to the back of the accessory 108 when the game control element 118 is in its gaming position. Alternatively, the aperture 136 may be positioned to align with the camera lens and/or flash 134 when the game control element 118 is in its gaming position, as shown in FIGS. 5, 9 and 13.

FIGS. 1-7 show the game control elements 118 and 120 in a stored position. In their stored position, the game control elements 118 and 120 may be located beneath the receptacle 104. In some embodiments, when the game control elements 118 and 120 are in the stored position, they may, along with the receptacle 104, appear to be an integral part of a case for a portable electronic device 102. In some embodiments, power to each game control element 118, 120 may shut off, or the game control element 118, 120 may be deactivated or in an inactive state, when that game control element 118, 120 is in its stored position.

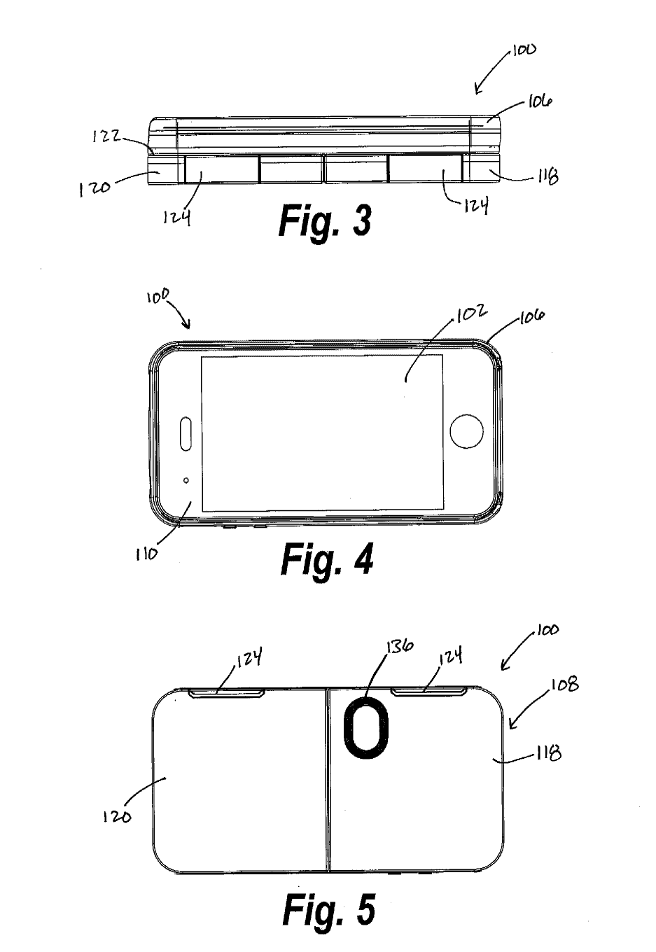

In FIGS. 8-13, the game control elements 118 and 120 are shown in their gaming positions. While in the gaming position, various controls 126, 128, 130, 132 (the embodiments and arrangements shown are not limiting) on the upper surfaces of the game control elements 118 (e.g., controls 126 and 128) and 120 (e.g., controls 130 and 132) are exposed laterally beyond the outer periphery of the receptacle 104 and, thus, beyond the outer periphery of an electronic device 102 carried by the receptacle 104, as depicted by FIGS. 8 and 12. Additional controls 138, 140 (e.g., a power switch and a light sensor, respectively, etc.) on an interior periphery of a game control element 120 may also be exposed when that game control element 120 is in its gaming position. In addition to controls 126, 128, 130 and 132 that are revealed when the game control elements 118 and 120 are in their gaming positions, and that are hidden beneath the receptacle 104 when the game control elements 118 and 120 are placed in their stored positions, as shown in FIGS. 3 and 5, the game control elements 118 and 120 may include peripheral controls 124 (e.g., buttons, triggers, etc.), which may be accessible regardless of the positions of the game control elements 118 and 120 (see also, FIGS. 11-13).

The game control elements 118 and 120 may be configured to communicate with a portable electronic device 102 in any suitable manner. Without limitation, the game control elements 118 and 120 may wirelessly couple with the electronic device (e.g., via a BLUETOOTH® wireless protocol, etc.). Alternatively, the accessory 108 may be configured to establish a wired connection between a portable electronic device 102 and the game control elements 118 and 120 when the portable electronic device 102 is inserted into the receptacle 104.

The game control elements 118 and 120 may also function and interact with a portable electronic device 102 in a manner known in the art to actuate desired video game functions.

Looking now to FIGS. 9 and 13, the accessory 108 may include a carriage that facilitates and/or controls movement of each game control element 118, 120 between its storage position and its gaming position. In the depicted embodiment, the carriage includes one or more guides 144, 146 that enable the game control elements 118 and 120 to move linearly toward and away from one other. The guides 144 and 146 may comprise tracks, or flanges, and/or slots that, along with other features of the carriage (e.g., springs, wheels, rack and pinion systems, etc.), enable the game control elements 118 and 120 to move between and to be maintained in two or more discrete positions. Other configurations of carriages and their respective guides (e.g., arcuate tracks, hinges, etc.) may be configured to enable the game control elements 118 and 120 to move in any other suitable manner relative to the receptacle 104 and, thus, relative to a portable electronic device 102 carried by the receptacle 104.

In some embodiments, game control elements 118 and 120 may be configured to move independently from one another. Thus, while one game control element 118 is in a gaming position, the other game control element 120 may be in a stored position, a gaming position, or some position between the stored and gaming positions. In other embodiments, the accessory 108 may be configured in such a way that the game control elements 118 and 120 move together; i.e., when one game control element 118 is moved to a certain position (e.g., its stored position, an intermediate position, its gaming position), the other game control element 120 is automatically carried to the same position (e.g., its stored position, an intermediate position, its gaming position).

As inferred previously, the delivery of power to the game control elements 118 and 120 (e.g., by way of a battery, etc.) may be controlled by way of a switch or button (e.g., control 138—FIG. 9, etc.). In some embodiments, the switch may be configured for selective control by a user, or manual operation. In other embodiments, operation of the switch may be automatic: as one or more game control elements 118, 120 are moved to its (their) gaming position(s), the game control elements 118 and 120 are turned “on,” or activated; as the game control elements 118 and 120 are moved to their stored positions, the game control elements 118 and 120 are turned “off,” or deactivated.

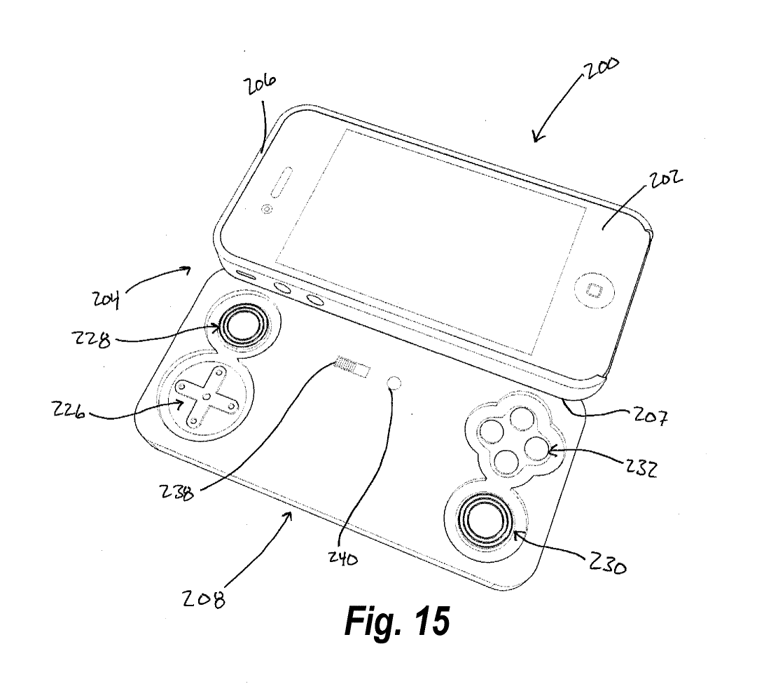

FIG. 15 illustrates another embodiment of accessory 208, which includes a receptacle 204 for receiving and holding a portable electronic device 202 to provide a gaming assembly 200. The accessory 208 includes a single game control element 218 that is configured to be moved between a storage position beneath the receptacle 204 and a gaming position (as depicted) in which various controls 226, 228, 230, 232, 238 (e.g., a power button, etc.) and 240 (a light sensor, etc.) are exposed laterally beyond a side wall 207 of the receptacle 204, and are accessible to a user.

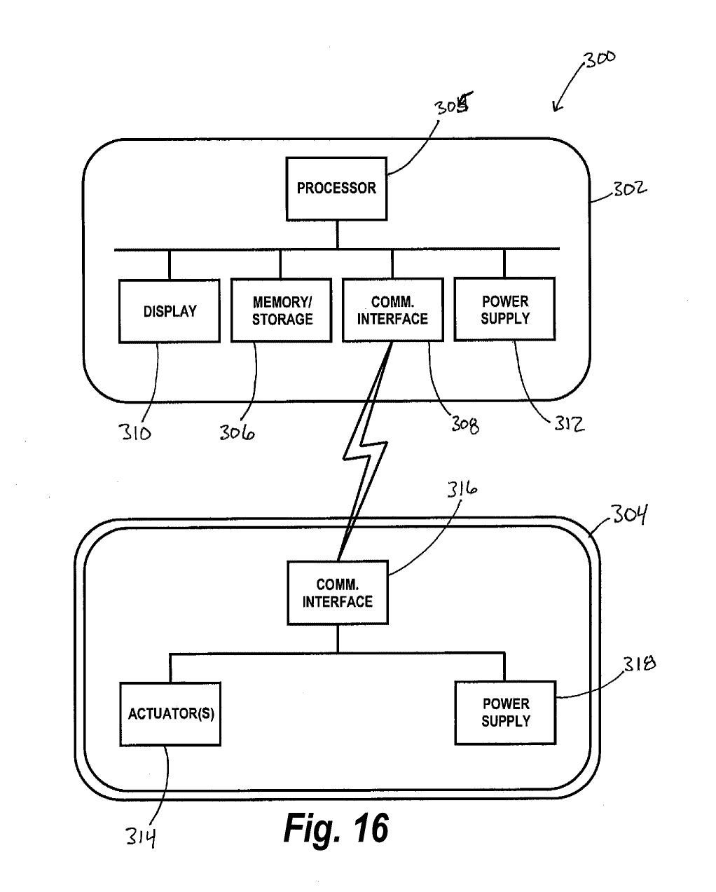

Turning now to FIG. 16, a schematic representation of a gaming system 300 is provided. The gaming system 300 includes a portable electronic device 300 and an accessory 304 for the portable electronic device 300.

The portable electronic device 300, which may comprise a smart phone, a portable media player, a tablet computer or the like, includes a processor 305, as well as memory 306 associated with the processor 305, a display 310 for receiving output images (e.g., video, etc.) from the processor 305 and optionally receiving inputs to be communicated to the processor 305, and one more communication interfaces 308, which may establish communication between the portable electronic device 302 an devices external thereto. A power supply 312, such as a battery, may provide power to one or more of the processor 305, the memory 306, the display 310 and the communication interface 308.

The accessory 304 may comprise one or more game control elements, such as the game control elements 118 and 120 shown in and described with reference to FIGS. 1-13 or the game control element 218 shown in FIG. 15. The accessory 304 includes actuators 314 or other controls (e.g., a power switch, a light sensor, etc.), as well as a communication interface 316 for communicating inputs received by the actuators 314 to the communication interface 308 and, thus, the processor 305 of a portable electronic device 302 to which the accessory 304 has been communicatively (and, optionally, physically) coupled. The accessory 304 may also include a power supply 318, such as a battery, for providing power to the actuators 314 and the communication interface 316.

With returned reference to FIGS. 1-13, a portable electronic device 102 may be assembled with an accessory 108. In some embodiments, such as that depicted by FIGS. 1-7, such assembly may comprise inserting the portable electronic device 102 into a receptacle 104 of the accessory 108. The accessory 108, or at least its receptacle 104, may be configured to protect the portable electronic device 102. By way of non-limiting example, portions of the portable electronic device 102 that are covered by the accessory 108 and its receptacle 104 may be protected from scratches that might otherwise occur from incidental contact (e.g., with hard surfaces; with keys coins or other objects; etc.) if those portions of the portable electronic device 102 were unprotected. As another example, the accessory 108 may protect the portable electronic device 102 from impacts, as may occur when the portable electronic device is accidentally (or intentionally) dropped, when other objects are dropped on the portable electronic device 102, or when other forces are applied to the portable electronic device 102.

With each game control element 118, 120 of the accessory 108 in a stored position, as shown in FIGS. 1-7, the portable electronic device may be used for a non-gaming function. Examples of nongaming functions include, without limitation, a telephone call, text messaging, e-mailing, playing audio, playing video viewing images, using the internet and executing a non-game app. Of course, in some embodiments, these functions may also be performed while one or more game control elements 118, 120 are in their gaming positions (see FIGS. 8-13 and 15). In some embodiments, a game control element 118, 120 may be used in the performance of a non-gaming function.

When a game control element 118, 120, 218 of an accessory 108, 208 is in a gaming position, as depicted by FIGS. 8-13 and 15, activated (or turned “on”) and communicatively coupled with the portable electronic device 102, 202, the game control element 118, 120, 218 may be used to control play of a video game executed by, or played on, the portable electronic device 102, 202. Video game control with the game control element 118, 120, 218 may be accomplished as an individual uses one or more controls 124, 126, 128, 130, 132.

Once game play is complete, each game control element 118, 120, 218 may be deactivated, or powered down or turned “off,” and placed in its storage position. While in its storage position, the game control element 118, 120, 218 and at least some of its controls 124, 126, 128, 130, 132, 138, 140 may be shielded and, thus, protected by a remainder of the accessory 108.

Although the foregoing disclosure provides many specifics, these should not be construed as limiting the scope of any of the appended claims, but merely as providing information pertinent to some specific embodiments that may fall within the scopes of the appended claims. Features from different embodiments may be combined. In addition, other embodiments of the disclosed subject matter that lie within the scopes of the appended claims may be devised. The scopes of the claims are, therefore, indicated and limited only by the plain language used in each claim and the legal equivalents to the elements recited by the claims. All additions, deletions and modifications to the disclosed subject matter that fall within the meaning and scopes of the claims are to be embraced by the claims.

What is claimed:

1. A case for a portable electronic device, comprising:
a base including an upper side and a lower side;
a receptacle on an upper side of the base, the receptacle configured to receive a portable electronic device; and
a game control element carried by the base.

2. The case of claim 1, wherein the receptacle comprises a protective case for the portable electronic device.

3. The case of claim 2, wherein the receptacle is configured to cover a back side of the portable electronic device and to engage and cover each peripheral corner of the portable electronic device.

4. The case of claim 2, wherein the receptacle and the base are integral.

5. The case of claim 1, wherein the receptacle is configured to rotate relative to the base.

6. The case of claim 5, wherein the receptacle is configured to orient a display of the portable electronic device in at least:
a portrait orientation relative to the game control element; and
a landscape orientation relative to the game control element.

7. The case of claim 1, wherein the game control element has:
a storage position in which the game control element is located beneath the receptacle; and
a gaming position in which at least a portion of the game control element extends laterally beyond the receptacle and is accessible at a location adjacent to a periphery of the receptacle.

8. The case of claim 7, wherein the game control element is configured to slide relative to the base, between the storage position and the gaming position.

9. The case of claim 8, wherein the game control element is configured to slide linearly along the base, between the storage position and the gaming position.

10. The case of claim 7, wherein the game control element is configured to rotate relative to the base, between the storage position and the gaming position.

11. The case of claim 7, wherein movement of the game control element into the gaming position activates the game control element.

12. The case of claim 7, wherein movement of the game control element into the storage position deactivates the game control element.

13. The case of claim 1, comprising at least two game control elements, a first game control element located at a first side of the receptacle, a second game control element located at an opposite side of the receptacle.

14. The case of claim 11, wherein the first side and the second side are opposite from one another.

15. The case of claim 13, wherein movement of one game control element between the storage position and the gaming position causes another game control element to move between the storage position and the gaming position.

16. A gaming system, comprising:
a portable electronic device for providing at least one game;
a base including an upper side and a lower side;
a receptacle on an upper side of the base, the receptacle configured to receive the portable electronic device; and
a pair of game control elements configured to communicate with the portable electronic device to actuate actions in the at least one game and carried by the base at opposite ends of the base, each game control element having:
a storage position in which the game control element is located beneath the receptacle; and
a gaming position in which at least a portion of the game control element extends laterally beyond the receptacle and is accessible at a location adjacent to a periphery of the receptacle.

17. The gaming system of claim 16, wherein the portable electronic device comprises a mobile telephone, a portable media player and a tablet computer.

18. The gaming system of claim 16, wherein the receptacle is configured to rotate relative to the base.

19. The gaming system of claim 18, wherein the receptacle is configured to orient a display of the portable electronic device in at least a landscape orientation relative to the pair of game control elements and a portrait orientation relative to the pair of game control elements.

20. The gaming system of claim 18, wherein, in the storage position, the pair of game controllers and the receptacle appear to be an integral protective case for the portable electronic device.

21. A method for using a portable electronic device for gaming, comprising:
assembling the portable electronic device with a protective case for gaming, including inserting the portable electronic device into a receptacle of the protective case;
moving at least one game control element of the protective case to a gaming position;
initiating game play on the portable electronic device;
using the at least one game control element to play the game.

22. The method of claim 21, further comprising:
operatively coupling the at least one game control element to the portable electronic device.

23. The method of claim 22, wherein operatively coupling comprises wirelessly coupling the at least one game control element to the portable electronic device.

24. The method of claim 21, further comprising:
moving the at least one game control element from the gaming position into a storage position; and
using the portable electronic device for a non-gaming purpose with the at least one game control element in the storage position.

25. The method of claim 24, wherein using the portable electronic device for the non-gaming purpose comprises at least one of making a phone call, texting, e-mailing, playing audio, playing video viewing images, using the internet and executing a non-game app.
